(19) United States
(12) Patent Application Publication
(10) Pub. No.: US 2024/0019208 A1
(43) Pub. Date: Jan. 18, 2024

(54) METHOD AND APPARATUS FOR RECOVERING CARBON DIOXIDE FROM A COMBUSTION ENGINE EXHAUST

(71) Applicant: LGE IP MANAGEMENT COMPANY LIMITED, Dunfermline, Fife (GB)

(72) Inventor: Nikola FELBAB, London (GB)

(73) Assignee: LGE IP MANAGEMENT COMPANY LIMITED, Dunfermline, Fife (GB)

(21) Appl. No.: 18/039,911

(22) PCT Filed: Dec. 1, 2021
(86) PCT No.: PCT/GB2021/053126

§ 371 Date: Jun. 1, 2023

(30) Foreign Application Priority Data
Dec. 7, 2020 (GB) 2019205.0

(51) Int. Cl. F25J 3/06

(52) U.S. Cl. CPC F25J 3/067; F25J 2210/70; F25J 2215/04; F25J 2220/82; F25J 2230/30; F25J 2245/02; F25J 2210/04; F25J 2270/02; F25J 2270/904; F25J 2210/62; F25J 2210/50

(57) ABSTRACT

A method and apparatus for recovering carbon dioxide (CO2) from an oxyfuel combustion engine exhaust stream is described. The method comprises: providing and separating an oxyfuel combustion engine exhaust stream to provide a first liquefied CO2 stream and a first waste gas stream; condensing at least a portion of the first waste gas stream to provide a partly condensed waste gas stream; and separating the condensed waste gas stream to provide a second waste gas stream, and a second liquefied CO2 stream.

The present invention relates to a method and apparatus for improving the recovery or capture of carbon dioxide from a combustion engine exhaust, in particular an oxyfuel internal combustion engine exhaust. Suitable fuels for an oxyfuel internal combustion engine exhaust include liquefied oxygen, and a liquefied hydrocarbon fuel such as liquefied natural gas.

For standard combustion in conventional combustion engines, the oxidant used is air, which comprises oxygen (˜21 mol %) and a substantial fraction of nitrogen (˜78 mol %). Nitrogen (N2), being an inert gas, does not participate in the combustion reaction, but it does reduce the combustion temperature. Due to the quantity of N2 in the intake air, exhaust gas typically contains predominantly N2, with carbon dioxide (CO2) and water being minor constituents. This dilution of exhaust CO2 with N2 renders separation to generate a pure CO2 stream for capture and storage (to avoid emission simply to atmosphere as a greenhouse gas) difficult.

Oxyfuel combustion is the process of burning a fuel and ‘pure’ oxygen instead of air as the primary oxidant. The resulting exhaust mostly comprises carbon dioxide and water. The water can easily be removed by ambient cooling, and it so it should be easier to capture the carbon dioxide using carbon capture and storage (CCS) techniques. Typically, CCS involves liquefying the gaseous carbon dioxide in the engine exhaust stream.

Combustion of a fuel with pure oxygen also leads to a high flame temperature that existing engines cannot tolerate. In order to overcome this problem, part of the exhaust gas can be recycled and mixed with the oxygen oxidant. As carbon dioxide is a major part of the exhaust gas, this involves recycling at least a portion of the carbon dioxide to act as an inert gas, to perform a similar temperature reduction during combustion within the engine as the nitrogen does in conventional combustion discussed above. Thus, the carbon dioxide capture and storage (CCS) need only recover the remaining carbon dioxide that is not recycled.

However, natural sources of hydrocarbon fuels typically include some nitrogen gas, which cannot economically be separated from natural gas during liquefaction. As the fuel for oxyfuel combustion is typically a liquefied hydrocarbon such as liquefied natural gas, with a portion being nitrogen, the use of such a fuel leads to a proportion of the exhaust gas being nitrogen. The oxygen used as the oxidant in oxyfuel combustion may also contain some impurities that are inert with respect to the combustion, such as nitrogen or argon. The nitrogen could be vented to atmosphere as waste gas once as much carbon dioxide as practicable has been removed from it. However, a significant portion of the waste gas is still carbon dioxide, such that this methodology still leads to a percentage of carbon dioxide atmospheric emission, which is undesired.

The present invention seeks to improve the carbon dioxide capture and storage from an oxyfuel combustion exhaust.

Thus, according to one embodiment of the present invention, there is provided a method of recovering carbon dioxide (CO₂) from an oxyfuel combustion engine exhaust stream, comprising at least the steps of:
(i) providing and separating an oxyfuel combustion engine exhaust stream to provide a first liquefied CO₂ stream and a first waste gas stream;
(ii) condensing at least a portion of the first waste gas stream to provide a partly condensed waste gas stream;
(iii) separating the condensed waste gas stream to provide a second waste gas stream, and a second liquefied CO₂ stream.

According to a second aspect of the present invention there is provided apparatus for recovering carbon dioxide (CO₂) from an oxyfuel combustion engine exhaust stream comprising:
(a) an exhaust gas separator to separate an oxyfuel combustion engine exhaust stream to provide a first liquefied CO₂ stream and a first waste gas stream;
(b) a waste gas condenser to at least partly condense the first waste gas stream and provide a partly condensed waste gas stream; and
(c) a waste gas separator to separate the partly condensed waste gas stream into a second waste gas stream, and a second liquefied CO₂ stream.

### DESCRIPTION OF THE DRAWINGS

Embodiments of the present invention will now be described by way of example only, and with reference to the accompanying drawings in which:

FIG. 1 is a schematic plan of a method of recovering carbon dioxide from an oxyfuel combustion engine exhaust stream;

FIG. 2 is a schematic plan of a method of recovering carbon dioxide from an oxyfuel combustion engine exhaust stream according to one embodiment of the present invention;

FIGS. 3-11 are schematic plans of variants of the method shown in FIG. 2;

FIG. 12 is a more detailed schematic plan of a method of recovering carbon dioxide from an oxyfuel combustion engine exhaust stream based on FIG. 1; and

FIG. 13 is a schematic plan of the method shown in FIG. 12 and including a method and apparatus according to embodiments of the present invention.

### DETAILED DESCRIPTION OF THE DRAWINGS

The present invention provides a method of recovering carbon dioxide from an oxyfuel combustion engine exhaust stream.

Oxyfuel combustion is the process of burning a fuel using pure oxygen instead of air as the primary oxidant. The primary exhaust emissions are water and carbon dioxide, and the water can easily be condensed and removed using ambient cooling, making the exhaust gas amenable to efficient carbon capture techniques

Carbon dioxide capture and storage (CCS) is an increasingly important system for reducing atmospheric carbon dioxide emissions from engines. For a modern conventional power plant, it can significantly reduce atmospheric carbon dioxide emissions. The engine exhaust gases can pass through one or more coolers and separators, in order to at least remove that portion of the exhaust gas that is water, typically as liquid water, and thus to concentrate the carbon dioxide.

In oxyfuel combustion applications, the concentrated carbon dioxide stream can then be partly used for recycling back into the engine as an inert gas to improve engine combustion control, including providing a temperature reduction function (like nitrogen when air is used in a standard combustion engine). Typically this is the major recycle process occurring.

Meanwhile, it is expected to recover from that portion of the exhaust gas that is not being used for recycle back into the engine, hereinafter termed a ‘recovery stream’, as much carbon as possible, as the recovery stream is still carbon-rich. The recovery stream can be processed by passing through various separation, compression, cooling and dehydration steps, in order to try and maximise the carbon capture by liquefaction of the carbon dioxide to form liquefied CO₂ (LCO2) (as a ‘useful product’), which can be easily used or stored, without requiring any atmospheric release or emission.

In one particular arrangement, the recovery stream passes through a ‘conditioner train’, involving a water knockout step (to further reduce the water content) prior to a pressure increasing device such as a compressor or fan. Compression is typically followed by cooling such as an aftercooler, following which there can be a dedicated dehydration process in order to further reduce the moisture content of the compressed gas. This can be followed by a condenser and a separator, in order to provide a final highly enriched liquefied CO₂ stream, comprising at least the majority of the carbon dioxide in the recovery stream.

The liquefied CO₂ stream can be defined as ‘captured carbon’, and it is that portion of the non-recycled exhaust gas that has been ‘usefully recovered’. However, there is a portion of the recovery stream that cannot been liquefied by the recovery processing. This is because the use of a hydrocarbon fuel, in particular methane or methane-rich fuels will typically result in such fuel including a percentage of nitrogen. It is usually not economically viable to be able to remove all of the nitrogen from a natural gas source during its processing for use as a fuel. Typically the processing involves liquefaction of the fuel, in order to allow its easier transportation from a source to a place of use.

Similarly, the production of oxidants such as liquefied oxygen by an air separation unit may also result in a portion of the oxidant being incondensible inert gases such as nitrogen and argon, which are incondensible at temperatures and pressure suitable for carbon dioxide liquefaction

As nitrogen (and any argon, etc.) are inert during combustion, its presence in the fuel and/or oxidant will result in its continuing presence in the exhaust gas. All conventional non-cryogenic coolers, knockout drums, separators etc. do not affect the phase or presence of inert incondensible gases in the exhaust stream, such that the final cooling and separating of a carbon dioxide-rich recovery stream (to provide a liquefied carbon dioxide stream as discussed above), results in a vent gas which includes that portion of the inert incondensible gas in the original hydrocarbon fuel or oxygen source stream.

It is possible to recycle some or all of the so-formed vent gas back into the combustion as discussed above, but this results in the accumulation of incondensible inert gas (nitrogen, argon, etc.) in the combustion exhaust stream, which leads to decreasing efficiency of the exhaust conditioning processes over time, and ultimately failure of the oxyfuel combustion system.

Thus, one possibility is to release the so-formed vent gas to atmosphere as waste gas. If the waste gas was 100% incondensible inert gas (that is, completely free of carbon dioxide), this would not result in any greenhouse gas emissions. However, whilst the cooling and liquefaction of the carbon dioxide by the conditioning processes known in the art is intended to be most efficient in carbon capture, it is not yet able to achieve close to 100% carbon capture efficiency in the presence of incondensible inert gases. As such, there is always a percentage of carbon dioxide that becomes part of the waste gas from the final liquid carbon dioxide separator. If such waste gas were vented to atmosphere, it would result in venting that portion of the waste gas that is carbon dioxide to the atmosphere, which would an undesired greenhouse gas emission.

In one embodiment of the present invention, there is provided a method of recovering carbon dioxide (CO₂) from an oxyfuel combustion engine exhaust stream, comprising at least the steps of:
(i) providing and separating an oxyfuel combustion engine exhaust stream to provide a first liquefied CO₂ stream and a first waste gas stream;
(ii) condensing at least a portion of the first waste gas stream to provide a partly condensed waste gas stream; and
(iii) separating the condensed waste gas stream to provide a second waste gas stream, and a second liquefied CO₂ stream.

The oxyfuel combustion engine exhaust stream for step (i) has typically already undergone an initial conditioning train or process or processes in order to remove a portion of the water in the exhaust stream, and/or to provide a recycle stream back into the combustion having a portion of carbon dioxide to help combustion control.

The oxyfuel combustion engine exhaust stream to be treated by the present invention has typically also undergone further conditioning to recover as much useful product as possible, the conditioning typically including further water removal, compression, cooling, condensing and separating, to provide a useful bottom liquefied carbon dioxide stream, and a top ‘waste’ gas stream, which is hereinafter defined as a “first waste gas stream”.

In one embodiment, the method of the present invention optionally comprises wherein the oxyfuel combustion engine exhaust stream is a portion of an initial oxyfuel combustion engine exhaust stream which is cooled, separated, compressed and dehydrated. Optionally, such an initial oxyfuel combustion engine exhaust stream is divided into a portion termed a recycle stream and a portion termed a recovery stream.

The present invention is not limited by the nature or the provision of the cooling required for the condensing process or processes applied to the oxyfuel combustion engine exhaust stream able to provide the first waste gas stream.

The first waste gas stream typically comprises a proportion of nitrogen and a proportion of gaseous carbon dioxide.

In steps (ii) and (iii) of the method of the present invention, the first waste gas stream is condensed to provide a partly condensed waste gas stream, followed by separating the condensed waste gas stream to provide a second waste gas stream and a second liquefied CO₂ stream. Optionally, the condensing of at least a portion of the first waste gas stream in step (ii) in the method of the present invention is provided by using one or more of the combustion engine fuel and/or oxidant source streams. Such streams typically have usable cooling duty if they are provided at sub-ambient temperatures, preferably below −50° C.

The condensing of at least a portion of the first waste gas stream is at a lower temperature than the condensing of the first waste gas stream.

Optionally, the condensing at least a portion of the first waste gas stream is carried out either by direct cooling, or by indirect cooling, or by both direct and indirect cooling, against a combustion engine fuel and/or oxidant source stream.

Direct cooling of the first waste gas stream can be provided by direct heat exchange through one or more suitable heat exchangers with a combustion engine fuel source stream, in a manner known in the art.

Indirect cooling of the first waste gas stream can be provided by one or more intermediate cooling mediums, systems or processes that heat exchange with a combustion engine fuel and/or oxidant source stream. Such intermediate cooling mediums, systems and processes are known in the art, including providing an intermediate cooling or refrigerant medium, able to pass between a heat exchanger in the path of the combustion engine fuel and/or oxidant source stream, and through one or more heat exchangers in the path of the first waste gas stream portion.

Thus, optionally, at least a portion of the first waste gas stream is cooled against at cooling medium cooled by one or more of the combustion engine fuel and/or oxidant source streams.

The skilled person understands that a combustion engine fuel and/or oxidant source stream can provide a cooling duty, generally based on its source temperature and/or pressure, and that prior to its use in the combustion engine, such cooling duty can be used either directly, indirectly or a combination of both, in a number of methods or processes to assist condensing at least a portion of the first waste gas stream.

The skilled person also understands that the arrangement of using cooling duty from a combustion engine fuel and/or source stream can be maximised, depending upon various factors including the size of the engine, the expected flow of the fuel source stream, and the expected amount of first waste gas stream to be condensed.

Typically, at least one of the combustion engine fuel and/or oxidant source streams is a cryogenic fuel and/or oxidant source stream. Various cryogenic hydrocarbon fuel source streams are known in the art, typically based on a liquefied hydrocarbon gas or gases.

In one embodiment, the fuel is a gas, such as methane, or a methane-rich mixture of two or more gases, typically hydrocarbon gases, suitable for an internal combustion engine. Thus, the method is particularly but not exclusively suitable for engines used for heavy machinery and ships' engines, as well as for example power generation for industries having combustible gas elements in the fuel gas.

One typical hydrocarbon cryogenic fuel source stream is liquefied natural gas (LNG). Other suitable fuel sources are natural gas liquid (NGL) or liquid petroleum gas (LPG) such as propane or butane. The present invention is not limited by the nature of the hydrocarbon fuel source.

For oxyfuel combustion, a source of oxygen is required. The provision of liquefied oxygen as an oxidant is well known in the art, and is not further discussed herein. Liquefied oxygen also has a usable cooling duty.

Optionally, the method of the present invention is able to recover carbon dioxide from a power generator, including gas turbines.

Optionally, the method of the present invention is able to provide a second waste gas stream which comprises <50% of the carbon dioxide in the first waste gas stream, optionally <75% of the carbon dioxide of the first waste gas stream.

In this way, the present invention significantly improves the efficiency of carbon capture from the exhaust gas, in particular from that portion of the exhaust gas that is not being used for recycle back into the engine, herein termed a recovery stream. After the recovery stream undergoes a first separation to provide a first liquefied CO₂ stream and a first waste gas stream, it is now possible by the method of the present invention to provide a carbon capture efficiency of >90% from the recovery stream. Indeed, the present invention is able to achieve a carbon capture efficiency of >95% or even >97% from the recovery stream.

Optionally, the method of the present invention is able to provide passing the second liquefied CO₂ stream to storage. The second LCO2 stream could be combined with the first LCO2 stream.

Optionally, the method of the present invention is able to provide recycling a portion or all of the second liquefied CO₂ stream back into the oxyfuel combustion engine.

Optionally, the method of the present invention is able to provide recycling a portion or all of the second liquefied CO₂ stream into the recovery stream.

In one embodiment of the present invention, there is provided a method of recovering carbon dioxide (CO₂) from an oxyfuel combustion engine exhaust stream, comprising at least the steps of:
dividing an oxyfuel combustion engine exhaust stream into a recycle stream and a recovery stream;
processing the recovery stream to provide a first liquefied CO₂ stream and a first waste gas stream;
condensing at least a portion of the first waste gas stream to provide a partly condensed waste gas stream; and
separating the partly condensed waste gas stream to provide a second waste gas stream, and a second liquefied CO₂ stream.

The present invention also provides apparatus for recovering carbon dioxide (CO₂) from an oxyfuel combustion engine exhaust stream comprising:
(a) an exhaust gas separator to separate an oxyfuel combustion engine exhaust stream to provide a first liquefied CO₂ stream and a first waste gas stream;
(b) a waste gas condenser to at least partly condense the first waste gas stream and provide a partly condensed waste gas stream; and
(c) a waste gas separator to separate the partly condensed waste gas stream into a second waste gas stream, and a second liquefied CO₂ stream.

Optionally, the cooling for the waste gas condenser is provided from one or more combustion engine fuel and/or oxidant source streams.

Optionally, the cooling for the waste gas condenser is by direct cooling, or by indirect cooling, or by both direct and indirect cooling, against a combustion engine fuel and/or oxidant source stream.

Optionally, the engine fuel and/or oxidant source stream is a cryogenic fuel source stream.

Optionally, one cryogenic fuel source stream is liquefied natural gas (LNG). Optionally, one cryogenic oxidant source stream is liquefied oxygen.

Optionally, a portion of the first waste gas stream is cooled by a cooling circuit having a cooling medium, which is cooled by one or more combustion engine fuel and/or oxidant source streams.

Optionally, the oxyfuel combustion engine exhaust stream is provided from an initial oxyfuel combustion engine exhaust stream which is cooled, separated, compressed and dehydrated.

Optionally, the second waste gas stream comprises <50% of the carbon dioxide in the first waste gas stream, optionally <75% of the carbon dioxide of the first waste gas stream.

Optionally, the apparatus is able to provide a carbon capture efficiency of >90% from the recovery stream, optionally >95% or >97% from the recovery stream.

Optionally, the apparatus further comprises storage for the second liquefied CO₂ stream.

Optionally, the apparatus further comprises a recycling loop to pass a portion of the second liquefied CO₂ stream into the oxyfuel combustion engine.

Optionally, the apparatus comprises:
a divider of an oxyfuel combustion engine exhaust stream into a recycle stream and a recovery stream;
one or more coolers, compressors and separators to separate the recovery stream into a first liquefied CO₂ stream and a first waste gas stream;
a waste gas condenser to at least partly condense the first waste gas stream and provide a partly condensed waste gas stream; and
a waste gas separator to separate the partly condensed waste gas stream into a second waste gas stream, and a second liquefied CO₂ stream.

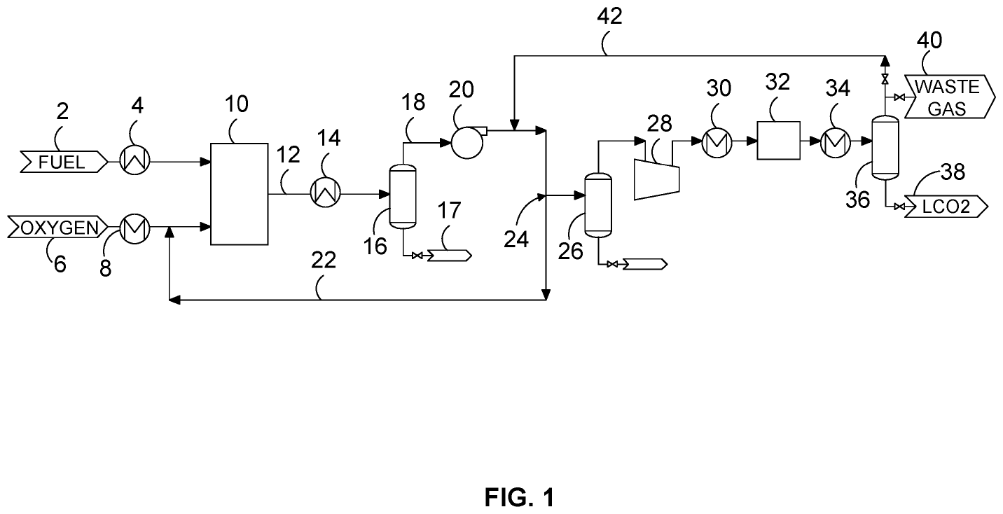

Referring to the drawings, FIG. 1 shows a schematic plan for some treatment of an oxyfuel combustion engine exhaust stream able to provide an oxyfuel combustion engine exhaust stream useable in the present invention.

FIG. 1 shows a fuel 2, such as liquefied natural gas (LNG) passing through a fuel heater 4, and a source of oxygen 6 passing through an oxygen heater 8, prior to both the fuel 2 and oxygen 6 passing into an internal combustion engine (ICE) 10. The fuel and the oxygen are combusted in the ICE 10 in a manner known in the art, and provide an exhaust gas 12. The exhaust gas passes through an exhaust cooler 14 and on to a water knockout 16, able to separate a portion of the water in the exhaust gas 12 through a bottom water stream 17, and a top gaseous stream 18 towards a recirculation fan 20. The recirculation fan 20 provides momentum for the gaseous stream 18 either around a recirculation loop 22 such that at least a portion of the gaseous stream 18, which is at least partially formed of carbon dioxide, is recycled back into the ICE 10 as a recycle stream in order to act as an inert gas to perform a temperature reduction function in a manner described above.

The combination of the oxygen 6 and recycled carbon dioxide in the recirculation loop 22, along with any moisture still in the recirculation loop 22 or any additional water added, allows the combustion process in the ICE 10 to be tailor-made to specific requirements or needs, by controlling the amounts or proportions of the oxygen, water and carbon dioxide individually.

FIG. 1 also shows a divider 24 such as a T-piece to divide the gaseous carbon dioxide stream 18 into a (typically major) recycle stream to pass into the recirculation loop 22, and a (typically minor) recovery stream to pass into a liquefied carbon dioxide (LCO2) conditioning train, according to the amount of recycling demand and other engine conditions.

The example of a first recovery conditioning train shown in FIG. 1 comprises a further water knockout drum 26, to further reduce the proportion of any water in the carbon dioxide gaseous stream prior to passage into a compressor 28, an aftercooler 30 to reduce the temperature of the compressed stream, a dedicated dehydration apparatus 32, and a condenser 34, prior to a separator 36. The separator 36 provides a LCO2 stream 38 in a manner known in the art, and a waste gas stream.

The cooler 30 and dehydration apparatus 32 can optionally be provided with drains in a manner known in the art, and controlled in a manner known in the art, with the primary purpose of seeking to prevent ice or gas hydrate formation in the condenser 34.

By liquefying as far as possible the remaining portion of CO₂ in the recovery stream, CO₂ emission to atmosphere from the combustion engine is at least partially reduced. However, one component of the first waste gas stream is nitrogen. Gaseous nitrogen is typically part of light hydrocarbon fuels, as a component of the extraction of the original hydrocarbon gas from the hydrocarbon gas source. It is not economically viable to remove all the nitrogen during liquefaction of the gaseous fuel to form a liquefied gaseous fuel that is easier for transportation between the source of the hydrocarbon gas and its use.

As mentioned above, it is possible to vent a portion 40 of the first waste gas stream to the atmosphere in order to relieve the method shown in FIG. 1 of the build-up of nitrogen. The nitrogen build-up would be a result of re-using at least some of the first waste gas stream in a waste gas recirculation loop 42 to pass back into the gaseous stream 18 prior to using a proportion of the gaseous stream in a recycling loop 22. As the nitrogen will not be liquefied by any of the condensation or separation processes used to condense and separate carbon dioxide, it will accumulate in the recirculation loops, which accumulation will decrease the efficiency of the remaining processes.

However, releasing the first waste gas stream 40 into atmosphere also releases the carbon dioxide in this top stream that was not liquefied and separated by the condenser 34 and separator 36. The release of such a stream to atmosphere is still undesirable and not considered maximally effective carbon capture.

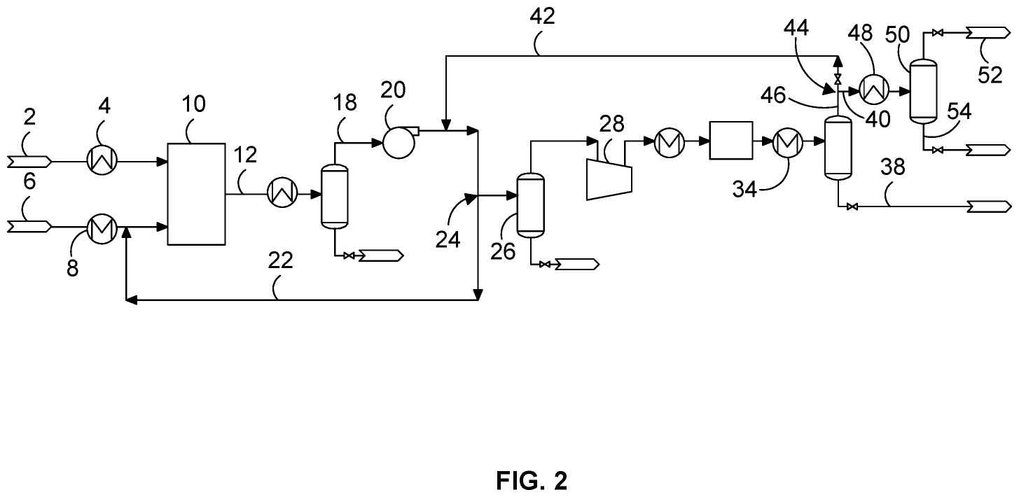

FIG. 2 shows an embodiment of the present invention wherein at least a portion 40 of the first waste gas stream 46 is diverted by a divider 44 to a second recovery process, so as to be at least partly condensed in a waste gas condenser 48, prior to passage into a waste gas separator 50, able to provide a second waste gas stream 52 and a second liquefied CO₂ stream 54.

The second waste gas stream 52 comprises <50% of the carbon dioxide in the first waste gas stream 40, optionally <60%, or <65% or <70% or <75% or <80% or lower of the carbon dioxide of the first waste gas stream 40.

In this way, the present invention significantly improves the carbon capture efficiency from the engine exhaust gas. It is possible for the present invention to provide an overall carbon capture efficiency of >90% from the initial recovery stream created by the divider 24. Indeed, the present invention is able to achieve a carbon capture efficiency of >92% or >95% or >96% or >97% or >98% or >99% from the recovery stream It is calculated that using an LNG fuel stream having a 1.5 mol % of nitrogen, the present invention can achieve a 97% carbon capture efficiency. This could be greater depending on the ‘quality’ of the LNG fuel. As such, the present invention can achieve close to or up to 100% carbon capture.

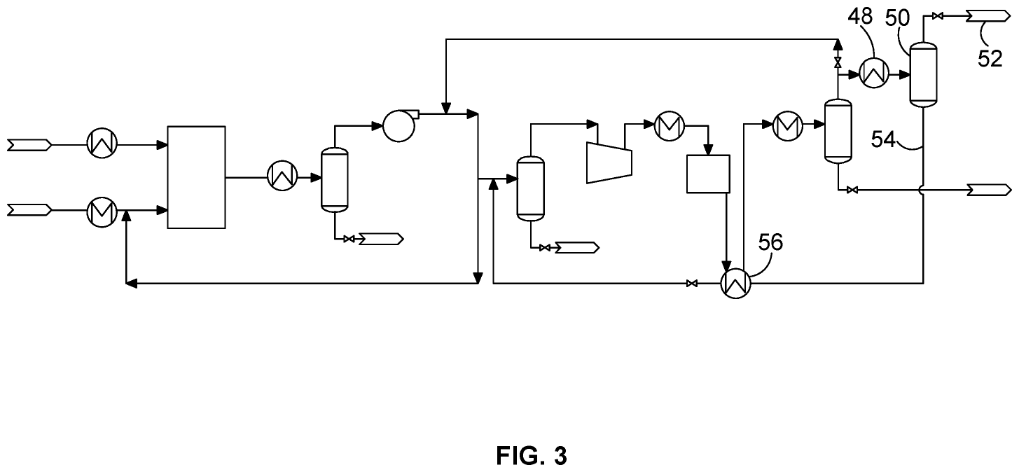

FIG. 3 shows a first variant of the embodiment of the present invention shown in FIG. 2, wherein the second LCO2 stream 54 passes through a LCO2 heater 56 able to prevent the formation of dry ice (solid carbon dioxide) that might result from its expansion prior to its recirculation

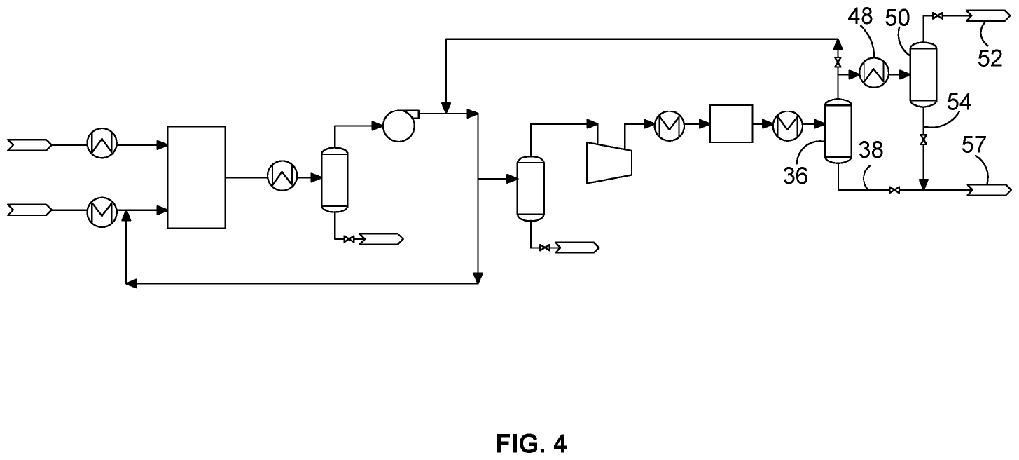

FIG. 4 shows another variant of the embodiment of the method of the present invention shown in FIG. 2, wherein the second LCO2 stream is sent to the storage, optionally to the same location or storage as the LCO2 38 provided from the bottom of the LCO2 separator 36.

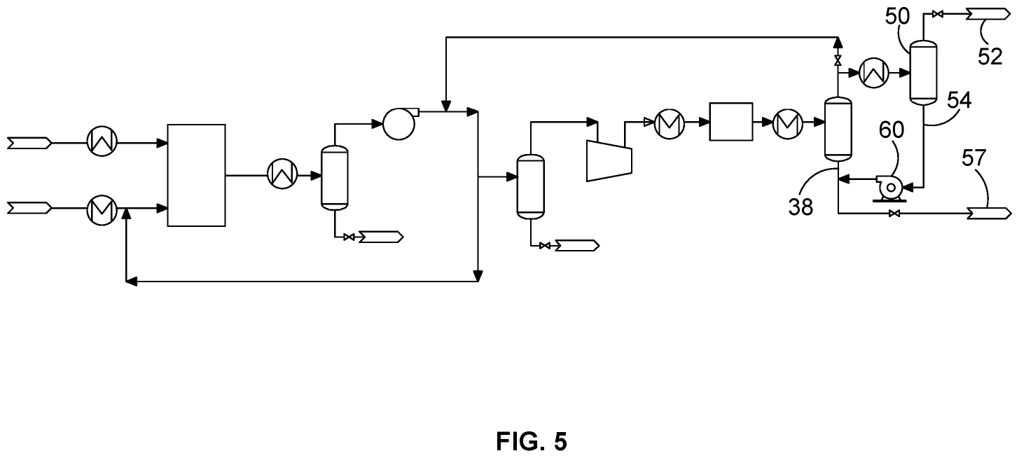

FIG. 5 shows a variant of the embodiment of the method of the present invention shown in FIG. 4, wherein a pump 60 is able to return the additionally recovered carbon dioxide to directly join the liquefied carbon dioxide stream 38 from the LCO2 separator 36.

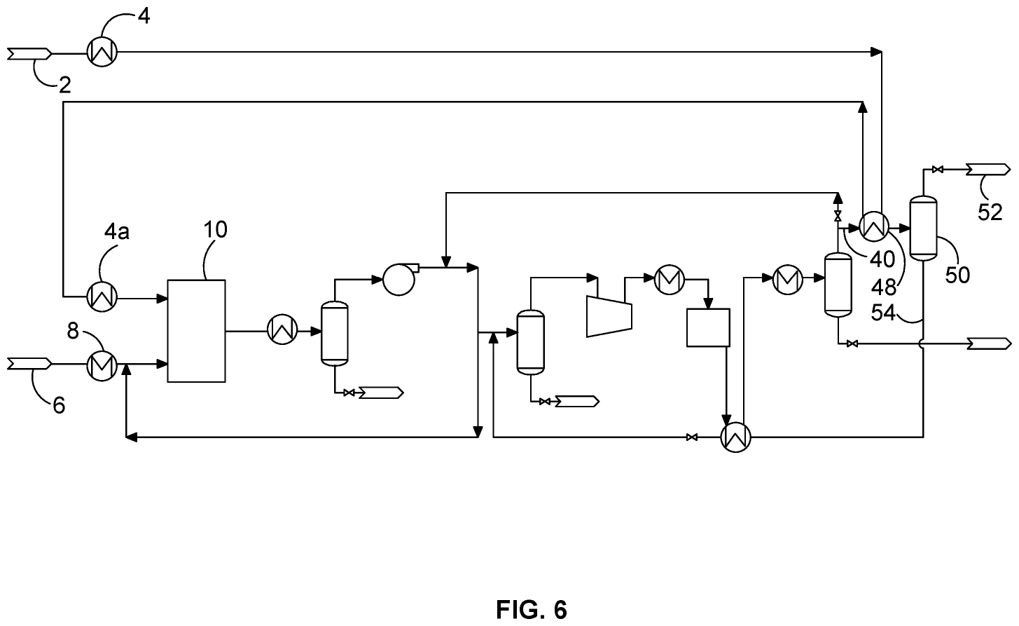

FIG. 6 is a variant of the embodiment of the method of the present invention shown in FIG. 3, wherein cooling duty required in the waste gas condenser 48 is provided directly by passage of a combustion engine fuel source stream, being the fuel 2, after its passage through the initial fuel heater 4, and prior to its passage through a further fuel heater 4a and its passage into the ICE 10. As such, the fuel 2 is used for direct cooling against the portion of the first waste gas stream 40.

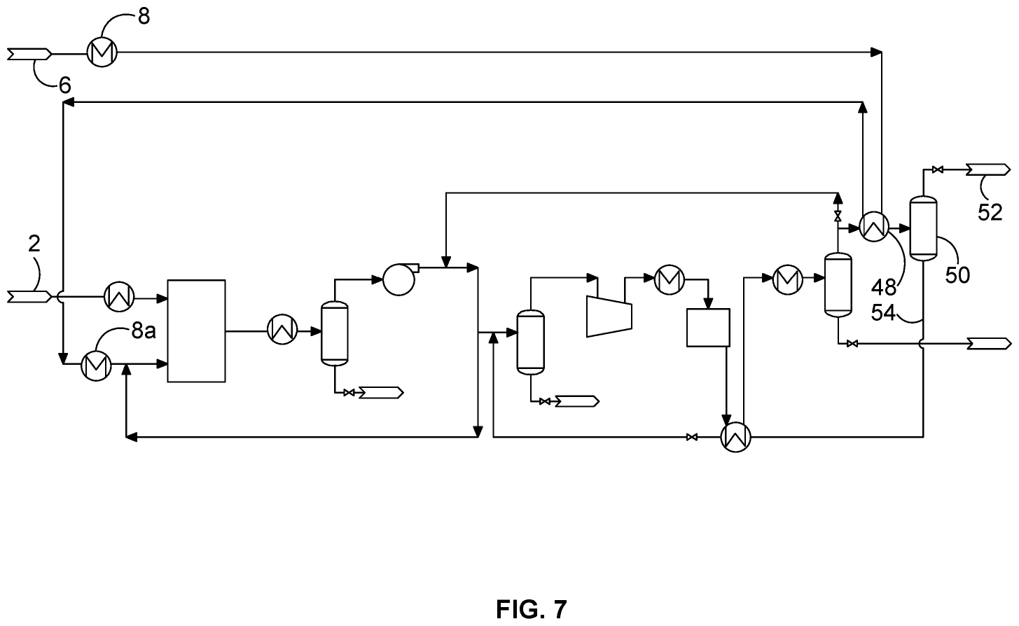

FIG. 7 is a variant of the embodiment of the method of the present invention shown in FIG. 3, wherein the cooling in the waste gas condenser 48 is provided by passage of the combustion engine oxidant source stream, being the oxygen 6, through a first oxygen heater 8, prior to direct passage through the waste gas condenser 48, prior to passage through a secondary oxygen heater 8a, and prior to entry into the internal combustion engine 10.

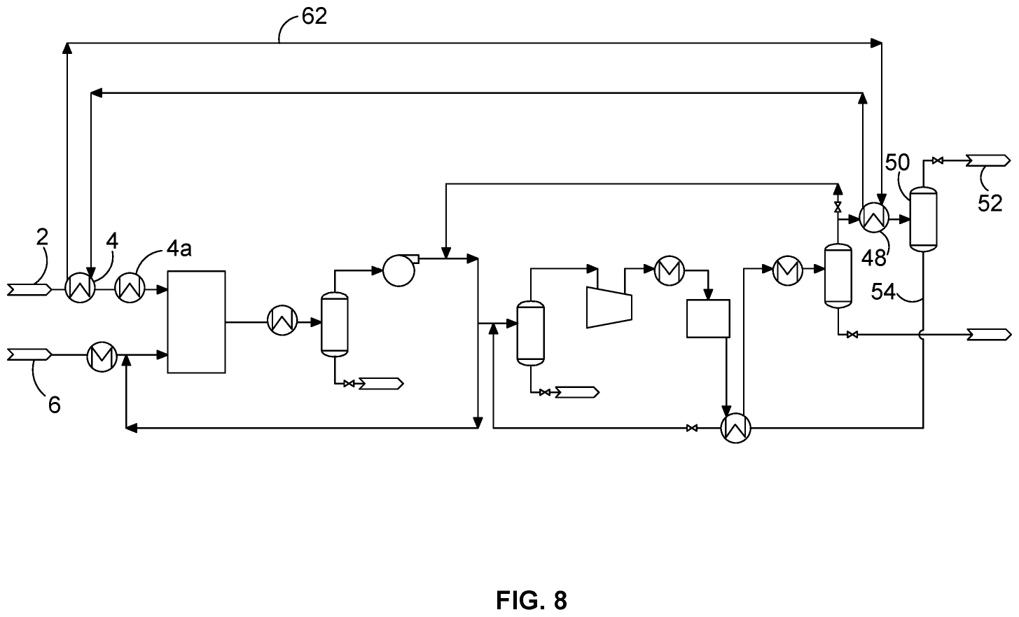

FIG. 8 is a variant of the embodiment of the method of the present invention shown in FIG. 6, now including a heat exchange circuit 62 comprising a heat exchange medium (working fluid), able to pass cooling duty between an initial fuel heater 4 and the waste gas condenser 48. In this way, cooling in the waste gas condenser 48 is provided indirectly from the fuel 2, via the first fuel heater 4.

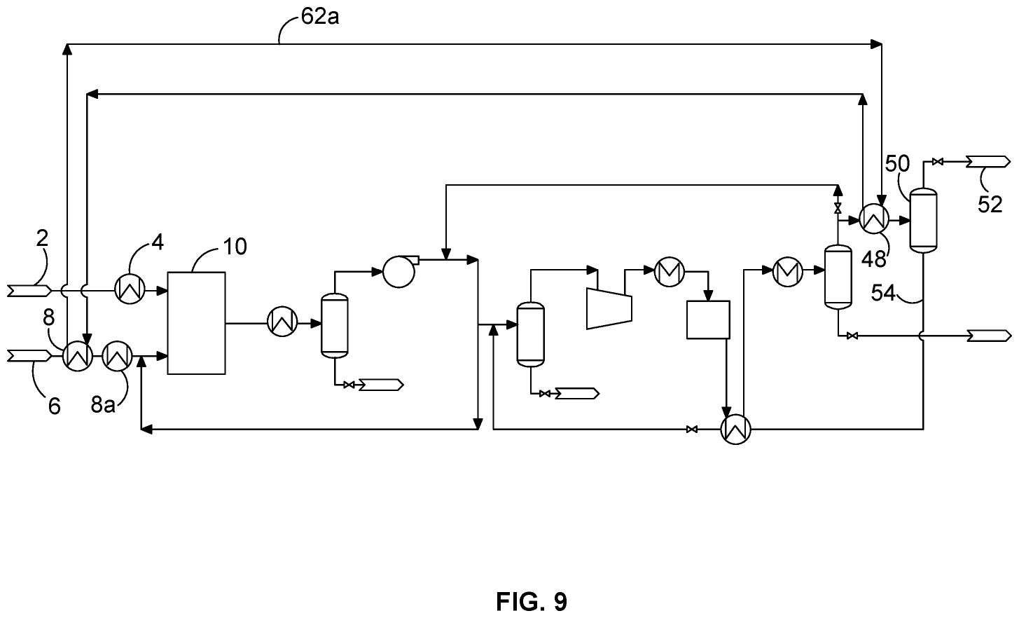

FIG. 9 is a variant of the embodiment of the method of the present invention shown in FIG. 7, wherein a heat exchange circuit 62a is provided between the waste gas condenser 48 and the initial oxygen heater 8, such that cooling for the waste gas condenser is provided indirectly from the liquefied oxygen 6 as the oxidant source stream.

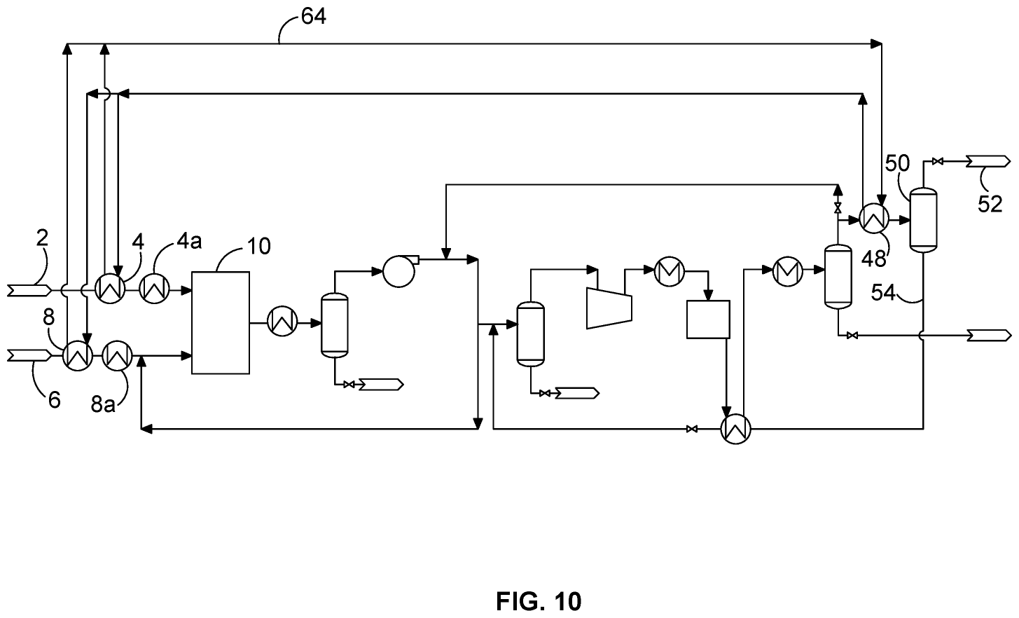

FIG. 10 is a variant of the embodiment of the method of the present invention shown in FIGS. 8 and 9, wherein a third heat exchange circuit 64 is shown to provide cooling the waste gas condenser 48, whose cooling is provided by a division of the heat exchange medium (working fluid) in the third cooling circuit 64 between the initial fuel heater 4 and the initial oxygen heater 8, such that some cooling duty is provided by both the fuel source stream and the oxidant source stream.

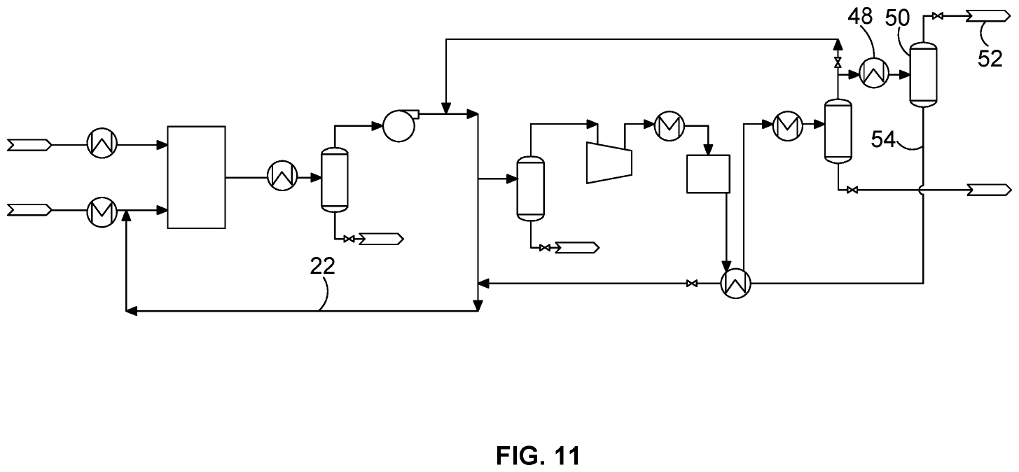

FIG. 11 shows another variant of the embodiment of the method of the present invention shown in FIG. 2, wherein the second LCO2 stream 54 is sent for engine recycling via the recirculation loop 22.

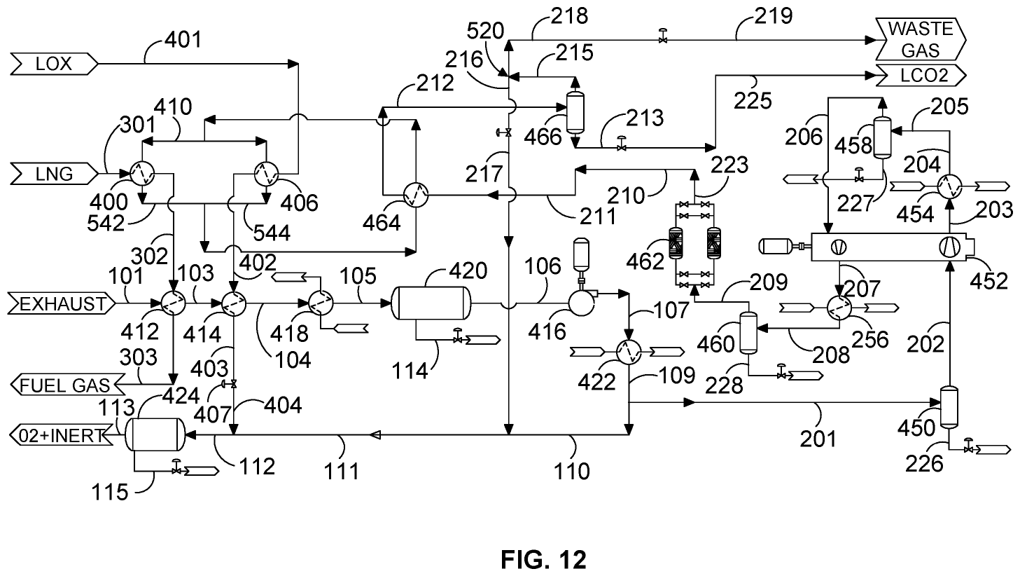

FIG. 12 shows a background to another example of the present invention.

In FIG. 12, a combustion fuel source stream of LNG (Stream 301) first passes through a LNG Vaporiser 400, where it cools the cold exchange working fluid (CEWF) in a CEWF circuit 410 described in more detail hereinafter. This CEWF circuit is used to prevent surface freezing of the CO₂ in the CO₂ Condenser 464 (discussed in more detail hereinafter). The CEWF is controlled at −50° C. in the CEWF circuit 410. In LNG Vaporiser 400, the LNG is vaporised fully and superheated to −60° C. (Stream 302).

This temperature is still too low for use in gas engines, so that further heating is required in the Fuel Gas Heater 412, which heats the fuel gas to +10° C. to form a fuel gas Stream 303. The heat source for this heating is the hot exhaust gas (Stream 101), the temperature of which is high enough not to require an intermediate working fluid.

The fuel gas stream 303 is sent to the gas engine (not shown), where the engine's gas valve unit (GVU) controls the flow of gas.

Similarly, an oxygen fuel source is provided as LOX Stream 401, which must be vaporised prior to being fed to the combustion engine. It is first passed through a LOX Vaporiser 406 to provide the balance of cooling required by the CO₂ Condenser 464, via the CEWF circuit 410. The warmer O₂ stream 402 leaves the LOX Vaporiser 406 as a vapour-liquid mixture at −157° C. For better controllability, this stream is then superheated to −140° C. (Stream 403) by an oxygen heater 414. The flow of O₂ is regulated to maintain a small target excess of O₂ in the engine exhaust Stream 101 by using a control valve 407, which expands Stream 403 to the exhaust recycle pressure of 0.3 bar (g) in Stream 404.

After combustion (not shown), the combustion exhaust gas stream 101 from the gas engine is at a temperature of +170° C., and is sent to the Fuel Gas Heater 412 and the Oxygen Heater 414 to be cooled and provide the heat source for heat exchange in 412 and 414 as discussed above. As the exhaust gas provides heat to the fuel gas and O₂, it successively decreases in temperature, leaving the Oxygen Heater 414 at a temperature of +145° C. (Stream 104).

Since a portion of the exhaust stream 101 must be recycled back to the engine, a Recirculation Fan 416 is required to overcome system pressure drops. As with any compression, the fan operates more efficiently with low suction temperatures. As such, the now cooler exhaust gas (Stream 104) is further cooled in a further Exhaust Cooler 418 to +45° C. (Stream 105) using cooling water. This cooling process condenses a significant portion of the water in the exhaust gas 104, which must be removed from the gas in the Fan Scrubber 420 (Stream 114) prior to entering the Recirculation Fan 416 (Stream 106). The Recirculation Fan 416 increases the exhaust gas pressure to 0.4 bar (g), which is accompanied by temperature elevation to around +62° C. as a discharge gas Stream 107.

As lower temperature is preferable for both subsequent compression of the recovered portion of the exhaust gas and for the engine intake, the discharge gas Stream 107 from the Recirculation Fan 416 is passed through a water-cooled Recycle Cooler 422, which returns the exhaust gas temperature to +45° C. as a cooled Stream 109, again leading to some condensation of water.

A portion of cooled Stream 109 is diverted to the carbon capture section of the process as a recovery stream 201 (discussed further hereinafter), while the remainder is recycled back to the engine as a first recycle Stream 110. A small, relatively O₂ -rich stream 217 from the carbon capture section (discussed further hereinafter) can also be returned to the recycle, to produce a combined recycle Stream 111, which is marginally colder and contains slightly more O₂ than Stream 110.

The O₂ feed in Stream 404, discussed earlier, is then introduced to the combined recycle Stream 111 to produce the required engine intake composition Stream 112. The addition of the cold O₂ in Stream 404 causes the exhaust temperature to drop to +28° C., and more water to be condensed out of Stream 112. This water is removed as Stream 115 from the Recycle Knockout 424, with the liquid-free gas being sent to the engine intake as Stream 113.

Meanwhile, the recovery stream 201 first passes through a Suction Scrubber 450 to remove water as Stream 226, such that no liquid enters the CO₂ Compressor 452 as Stream 202.

In the CO₂ Compressor 452, the gas will undergo at least two, and possibly three (not shown), stages of compression. After each compression stage, the pressure and temperature of the gas will rise. Thus, after each compression stage, the gas is cooled to +45° C. (firstly in an Intercooler 454 after the first compression stage, and secondly in an aftercooler 456 after the final compression stage), and water is knocked out after each cooling (Streams 227 and 228) by an interstage knockout drum 458 and a final discharge knockout drum 460. The compressed gas ultimately leaves the compression process as a compressed Stream 209 at +45° C. and 17 bar (g), but also as a water-saturated gas.

In order to prevent any ice or gas hydrate formation during the subsequent CO₂ condensation, the compressed gas Stream 109 is passed through a desiccant bed 462, to adsorb moisture in the stream, producing a dry Stream 210.

The dry stream 210/211 passes through a CO₂ Condenser 464, where the cold CEWF in the CEWF circuit 410 cools the compressed, dry CO₂ stream to −31° C., causing the majority of the CO₂ to condense. Due to the presence of incondensibles, such as nitrogen or excess O₂ in the exhaust gas, the post-condenser Stream 212 cannot condense fully at these conditions. The post-condenser Stream 212 is separated in the Liquefied CO₂ Separator 466 to provide a first LCO2 Stream 213 and a first waste gas stream 215. The LCO2 product Stream 213 from the Liquefied CO₂ Separator 466 can be sent as Stream 225 to LCO2 storage for subsequent transport or use.

Part of the first waste gas stream 215 can be expected to be returned to the exhaust recycle as a recycle Stream 216. This has the additional benefit of minimising the O₂ feed, as less O₂ is wasted.

However, the first waste gas stream 215 now has the highest percentage of the incondensible gases, in particular the nitrogen content of the LNG fuel stream 301. Returning all the incondensible gases back into the recycle would lead to an accumulation of the incondensibles over time, and so to a loss of efficiency and indeed ultimately failure of the oxyfuel combustion system.

But the first waste gas stream 215 also still contains around 81 mol % carbon dioxide, so that venting the remaining portion of the first waste gas stream 218/219 as waste gas also vents the carbon dioxide still in the first waste gas stream 215.

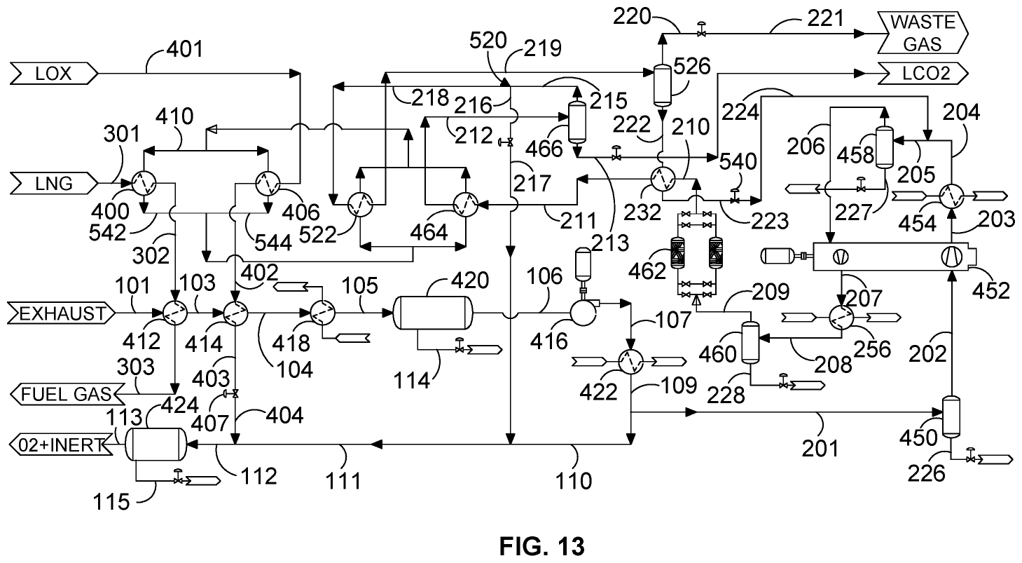

FIG. 13 shows the application of embodiments of the method and apparatus of the present invention to the plan shown in FIG. 12.

FIG. 13 shows that instead of venting Stream 218, there is a diversion at junction 520 of the relevant portion of Stream 218 of the first waste gas stream 215 into a Waste Gas Condenser 522, for condensing that portion 218 of the first waste gas stream 215 to provide a partly condensed waste gas stream 219. The partly condensed waste gas stream 219 then passes into a Waste Gas Separator 526 and is separated to provide a second waste gas stream 220 with a significantly reduced carbon dioxide proportion, and a second liquefied carbon dioxide stream 222.

The second LCO2 stream 222 can be passed through a CO₂ Recovery Heater 532 to prevent the formation of dry ice in Stream 224 after the expansion across valve 540, prior to combining with stream 204 prior to re-entry into the interstage knockout drum 458.

The skilled reader can see that the second LCO2 stream 222 can be passed elsewhere either in the circuit shown in FIG. 13, or for storage with the first LCO2 stream 213.

FIG. 13 shows the Waste Gas Condenser 522 being provided by cooling duty from a cold exchange loop 410, which is provided by streams 542 and 544 provided from a first LNG Vaporiser 400 and a first LOX Vaporiser 406. Cooling in the LNG Vaporiser 400 and LOX Vaporiser 406 is provided from the initial LNG fuel stream 301 and initial LOX fuel stream 401 as discussed above. The cold exchange loop 410 can be provided both to the Waste Gas Condenser 522 and the CO₂ Condenser 464, prior to recirculation back towards the first LNG Vaporiser 400 and first LOX Vaporiser 406 in the exchange loop 410.

The skilled reader can see that the cooling for the Waste Gas Condenser 522 could be provided directly from the first LNG Vaporiser 400 and/or the first LOX Vaporiser 406, or indeed from another cooling source.

The method shown in FIG. 13 can be calculated to achieve best cooling duty arrangements depending upon the amounts of fuel sources, the amounts of liquefied carbon dioxide, efficiency of the engine, etc. desired in order to provide best possible cooling duty to at least the Waste Gas Condenser 522, to maximise the CO₂ condensation in the first waste gas stream portion 218 sent thereto.

By way of example only, details and parameters of the captured ‘useful product’ liquefied CO₂ stream 213, the portion 218 of the first waste gas stream 215, and the second waste gas stream 220 are as follows:

| | | FIG. 12 | | FIG. 13 | | |
|---|---|---|---|---|---|---|
| | | 213 | 218 | 213 | 218 | 220 |
| Temperature | ° C. | −31.0 | −31.0 | −31.0 | −31.0 | −45.0 |
| Pressure | bar(g) | 16.70 | 16.70 | 16.70 | 16.70 | 16.40 |
| Mass flow | kg/h | 2743.5 | 500.0 | 3090.8 | 500.0 | 167.3 |
| Molar flow | kmol/h | 62.5 | 12.1 | 70.4 | 12.1 | 4.5 |
| Vapour fraction | — | 0.000 | 1.000 | 0.000 | 1.000 | 1.000 |

| | | | | | |
|---|---|---|---|---|---|
| Molar composition | | | | | |
| CH4 | — | — | — | — | — |
| CO2 | 0.9914 | 0.8096 | 0.9914 | 0.8096 | 0.5192 |
| H2O | — | — | — | — | — |
| O2 | 0.0059 | 0.1172 | 0.0058 | 0.1152 | 0.2882 |
| N2 | 0.0027 | 0.0732 | 0.0028 | 0.0752 | 0.1926 |

| | | | |
|---|---|---|---|
| Carbon capture efficiency | % | 86.4 | 96.8 |

The present invention provides a method and apparatus particularly able to further use the cooling duty available from the use of one or more combustion engine fuel and/or oxidant sources, in particular the use of a cryogenic fuel source stream such as liquefied natural gas, and/or a cryogenic oxidant source stream such as liquefied oxygen.

The present invention is not limited in the nature of the combustion engine fuel sources, or the order or location of suitable heat exchangers able to carry out the steps of the method of recovering carbon dioxide from any oxyfuel combustion engine exhaust stream in order to provide a second waste gas stream having reduced, preferably wholly or substantially minimised, the amount of carbon dioxide therein. Thus, it is possible that the second waste gas stream may be released to the atmosphere, with de minimis release of carbon dioxide in the oxyfuel combustion engine exhaust stream.

1. A method of recovering carbon dioxide (CO₂) from an oxyfuel combustion engine exhaust stream, comprising at least the steps of:
providing an oxyfuel combustion engine exhaust stream separating the oxyfuel combustion engine exhaust stream to provide a first liquefied CO₂ stream and a first waste gas stream;
condensing at least a portion of the first waste gas stream to provide a partly condensed waste gas stream; and
separating the partly condensed waste gas stream to provide a second waste gas stream and a second liquefied CO₂ stream.

2. The method as claimed in claim 1, wherein the condensing of the at least a portion of the first waste gas stream is provided by using one or both of a combustion engine fuel stream and an oxidant source stream.

3. The method as claimed in claim 1, wherein the condensing of the at least a portion of the first waste gas stream is provided by one of direct cooling, indirect cooling, or both direct and indirect cooling, and by using one or both of a combustion engine fuel stream and an oxidant source stream.

4. The method as claimed in claim 2, wherein the one or both of the engine fuel stream and the oxidant source stream are either a cryogenic fuel source stream or a cryogenic oxidant source stream.

5. The method as claimed in claim 4, wherein the cryogenic fuel source stream is a liquefied natural gas (LNG).

6. The method as claimed in claim 4, wherein the cryogenic oxidant source stream is a liquefied oxygen.

7. The method as claimed in claim 4, wherein the at least a portion of the first waste gas stream is cooled against a heat exchange medium cooled by the one or both of the combustion engine fuel and the cryogenic oxidant source stream.

8. The method as claimed in claim 1, wherein the oxyfuel combustion engine exhaust stream is provided from a power generator.

9. The method as claimed in claim 1, wherein the oxyfuel combustion engine exhaust stream is provided from an initial oxyfuel combustion engine exhaust stream that has been cooled, separated, compressed and dehydrated.

10. The method as claimed in claim 1, wherein the second waste gas stream comprises <75% of the carbon dioxide of the first waste gas stream.

11. The method as claimed in claim 1, wherein a carbon capture efficiency of >90% is provided from a recovery stream of the oxyfuel combustion engine exhaust stream.

12. The method as claimed in claim 1 further comprising directing the second liquefied CO₂ stream to storage.

13. The method as claimed in claim 1 further comprising recycling at least a portion of the second liquefied CO₂ stream into a oxyfuel combustion engine that is providing the oxyfuel combustion engine exhaust stream.

14. The method as claimed in claim 1 further comprising recycling at least a portion of the second liquefied CO₂ stream into a recovery stream of the oxyfuel combustion engine exhaust stream.

15. The method as claimed in claim 1 further comprising:
dividing the oxyfuel combustion engine exhaust stream into a recycle stream and a recovery stream; and
separating the recovery stream to provide the first liquefied CO₂ stream and the first waste gas stream.

16. Apparatus for recovering carbon dioxide (CO2) from an oxyfuel combustion engine exhaust stream comprising:
(a) an exhaust gas separator to separate an oxyfuel combustion engine exhaust stream into a first liquefied CO₂ stream and a first waste gas stream;
(b) a waste gas condenser to at least partly condense the first waste gas stream and to provide a partly condensed waste gas stream; and
(c) a waste gas separator to separate the partly condensed waste gas stream into a second waste gas stream and a second liquefied CO₂ stream.

17. The apparatus as claimed in claim 16 wherein the cooling for the waste gas condenser is provided from one or both of a combustion engine fuel stream and an oxidant source stream.

18. The apparatus as claimed in claim 16 wherein the cooling for the waste gas condenser is provided by one of direct cooling, indirect cooling, or both direct and indirect cooling, and by using one or both of a combustion engine fuel stream and an oxidant source stream.

19. The apparatus as claimed in claim 17, wherein the engine fuel source stream is a cryogenic fuel source stream.

20. The apparatus as claimed in claim 19 wherein the cryogenic fuel source stream is liquefied natural gas (LNG).

21. The apparatus as claimed in claim 19 wherein the cryogenic oxidant source stream is liquefied oxygen.

22. The apparatus as claimed in claim 19 wherein the at least a portion of the first waste gas stream is cooled by a cooling circuit comprising a cooling medium cooled by the one or both of the combustion engine fuel and the oxidant source stream.

23. The apparatus as claimed in claim 16 further comprising an internal combustion engine for providing the oxyfuel combustion engine exhaust stream.

24. The apparatus as claimed in claim 16, wherein the oxyfuel combustion engine exhaust stream is provided from an initial oxyfuel combustion engine exhaust stream that has been cooled, separated, compressed and dehydrated.

25. The apparatus as claimed in claim 16, wherein the second waste gas stream comprises <75% of the carbon dioxide of the first waste gas stream.

26. The apparatus as claimed in claim 16, wherein a carbon capture efficiency of >90% from a recovery stream of an oxyfuel combustion engine exhaust stream.

27. the apparatus as claimed in claim 16 further comprising storage for the second liquefied CO₂ stream.
